(19) United States
(12) Patent Application Publication
(10) Pub. No.: US 2020/0131301 A1
(43) Pub. Date: Apr. 30, 2020

(54) SHELF-STABLE RIGID FOAM FORMULATIONS

(71) Applicant: Dow Global Technologies LLC, Midland, MI (US)

(72) Inventors: Adebola O. Ogunniyi, Freeport, TX (US); Thomas P. Willumstad, Lake Jackson, TX (US); Phillip S. Athey, Freeport, TX (US)

(73) Assignee: Dow Global Technologies LLC, Midland, MI (US)

(21) Appl. No.: 16/493,651

(22) PCT Filed: Mar. 14, 2018
(86) PCT No.: PCT/US2018/022400

§ 371 Date: Sep. 12, 2019

Related U.S. Application Data
(60) Provisional application No. 62/471,144, filed on Mar. 14, 2017.
(60) Provisional application No. 62/564,768, filed on Sep. 28, 2017.

(51) Int. Cl. C08G 18/38; C08J 9/14; C08G 18/48; C08G 18/22; C08G 18/76; C08G 18/09

(52) U.S. Cl. CPC C08G 18/3876; C08J 9/147; C08G 18/4854; C08G 18/222; C08G 18/4829; C08G 2101/0025; C08G 18/7664; C08G 18/092; C08J 2375/08; C08J 2205/10; C08G 18/4816

(57) ABSTRACT

The shelf life of B-side compositions comprising a polyol, a surfactant, a blowing agent, an organometallic or metal salt catalyst wherein the metal of the catalyst comprises Zn or Bi, and from 1 to 10 weight percent water is improved by the addition of a thiol compound.

### FIELD

The disclosure relates to polyol premix compositions. More specifically, it relates to polyol premix compositions that are useful for the preparation of rigid foams.

### BACKGROUND

With the use of halogenated olefin blowing agents in the production of polyurethane and/or polyisocyanurate rigid foams, particularly trans-1,3,3,3-tetrafluoropropene and 1-chloro-3,3,3-trifluoropropene, it has been observed that when such species are premixed with polyols, catalysts, surfactants and flame retardants (B-side of the formulation), and left in storage at ambient conditions, there are gradual decomposition reactions that occur in the formulation resulting in deterioration of the foam quality and changes in the reactivity and properties of the formulation. These negative effects are worsened at higher temperatures and/or in the presence of water. It would be desirable to have a B-side composition having improved shelf life.

### SUMMARY

The B-side composition of the disclosure is such a B-side composition useful for preparing a rigid foam, the composition comprising a polyol, a surfactant, a blowing agent, a thiol compound, from 1 to 10 weight percent water, based on the weight of the composition, and an organometallic or metal salt catalyst wherein the metal of the catalyst comprises Zn or Bi.

Surprisingly, the B-side the composition of the disclosure has improved shelf life.

### BRIEF DESCRIPTION OF THE DRAWINGS

FIGS. 1-4 are graphical representations of the foam height versus time accelerated aging results for Ex.s 1-3 and C.E. 4, respectively.

FIGS. 5 and 6 are graphical representations of the foam height versus time accelerated aging results for Ex. 5 and C.E. 6, respectively.

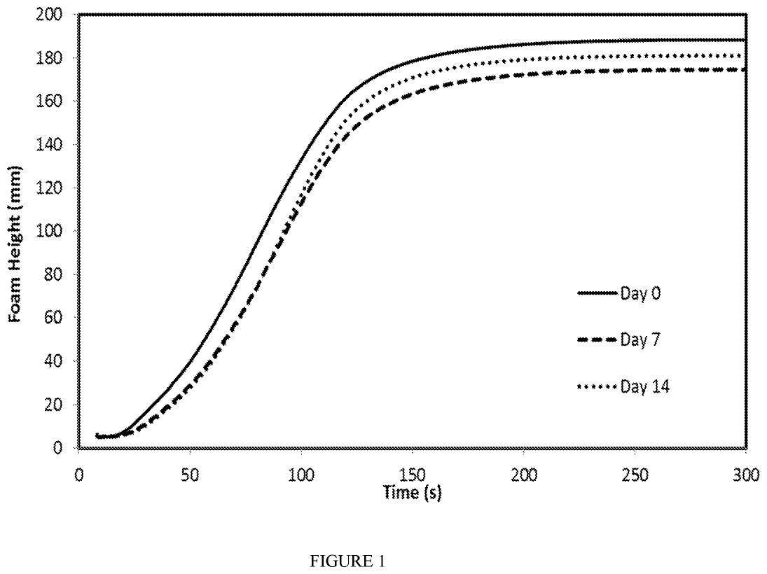

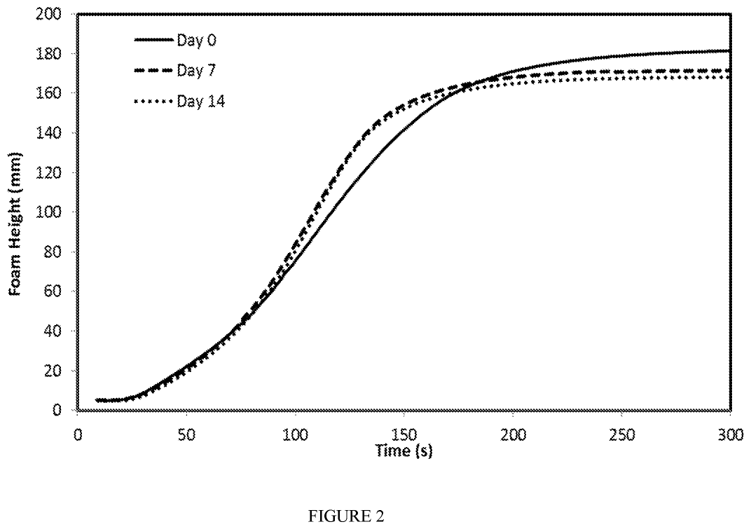

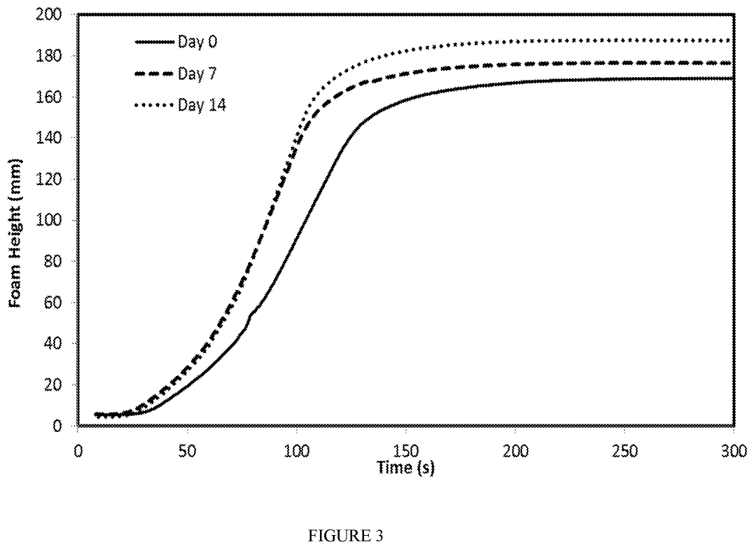

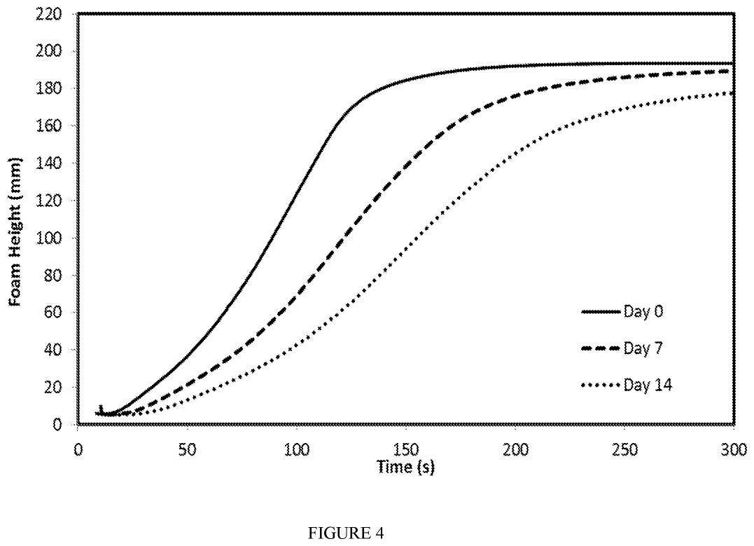

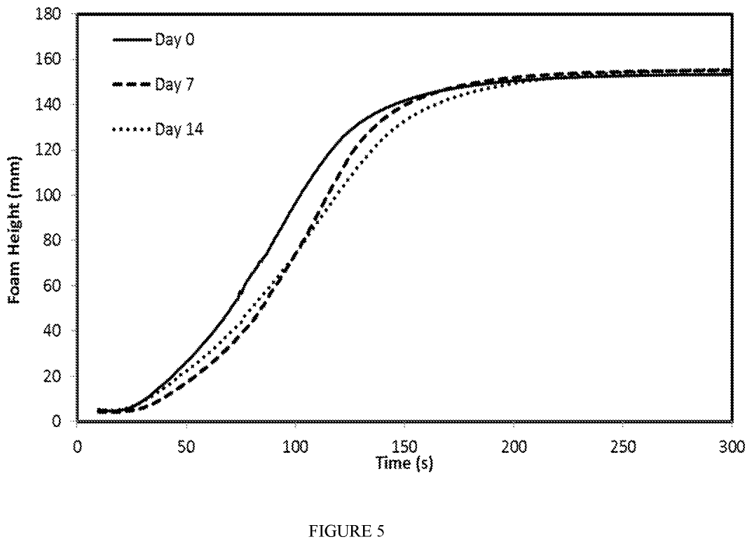

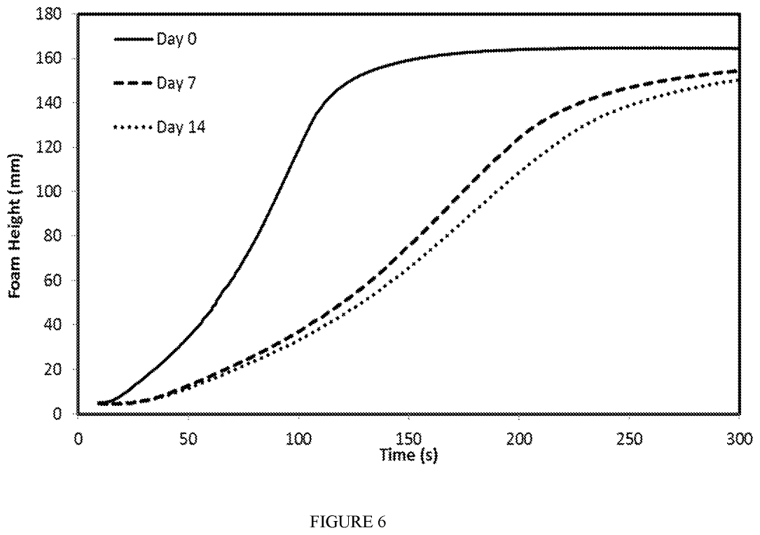

### DETAILED DESCRIPTION

The disclosure provides a high-water content polyol premix composition that comprises a combination of a blowing agent, one or more polyols, one or more surfactants, a thiol, from 1 to 10 weight percent water, and an organometallic or metal salt catalyst. In addition, the disclosure includes a process for the preparation of such a composition.

The disclosure also provides a method of preparing a polyurethane or polyisocyanurate foam comprising reacting an organic polyisocyanate with the polyol premix composition.

As used herein, the terms “a,” “an,” “the,” “at least one,” and “one or more” are used interchangeably. The terms “comprises” and “includes” and variations thereof do not have a limiting meaning where these terms appear in the description and claims. Thus, for example, “a” material can be interpreted to mean “one or more” materials, and a composition that “includes” or “comprises” a material can be interpreted to mean that the composition includes things in addition to the material.

“Complex” means a coordination compound formed by the union of one or more electronically rich molecules or atoms capable of independent existence with one or more electronically poor molecules or atoms, each of which is also capable of independent existence.

Unless stated to the contrary, implicit from the context, or customary in the art, all parts and percentages are based on weight and all test methods are current as of the filing date of this disclosure. The abbreviation “wt. %” stands for weight percent.

“Shelf life of at least 4 months” means the time required for at least one of (a) the measured reactivity (any one of the cream, gel and tack-free times) of the formulation or (b) the free-rise density of the resulting foam product; to change by >25%, compared to the corresponding time for the initial control sample, in handmix cup foam samples as determined by the Accelerated Aging Study Procedure described hereinbelow. This test is predicted to mimic changes that would be observed during storage at ambient conditions for >4 months.

As used herein, the terms “polyol premix composition” and “B-side composition” are used interchangeably.

As used herein, the term “HFO” stands for hydrofluoroolefin. As used herein, the term “HCFO” stands for hydrochlorofluoroolefin.

“Stoichiometric excess,” as used in connection with the thiol compound, means that the number of moles of thiol moieties present exceeds the number of moles of active metal species in the metallic catalyst. For example, when the catalyst is 1 mole of a divalent Zn compound, then more than one mole of a monofunctional thiol compound is employed.

Water is employed in the polyol premix composition. The water is employed in an amount sufficient to, when the premix is employed to make a foam, make a rigid foam with a free-rise density of 0.5-20.0 lbs/ft³, preferably 1.2-2.5 lbs/ft. In various embodiments, the polyol premix comprises from 1 to 10 wt. % water, from 2 to 5 wt. % water or from 3 to 5 wt. % water, based on the weight of the polyol premix composition. The amount of water includes water from any source, such as the blowing agent or other components of the composition of the disclosure.

A thiol is employed in the polyol premix composition. A “thiol” is an organic compound having at least one —SH (mercapto) group. In one embodiment, the thiol compound has from 3 to 25 total carbon atoms, preferably from 5 to 17 carbon atoms. The thiol is employed in an amount that is a stoichiometric excess, as that term is defined hereinabove, in relation to the metallic catalyst. In various embodiments, the polyol premix comprises from 0.0001 to 10 wt. % thiol, from 0.01 to 5.0 wt. % thiol or from 0.1 to 1.5 wt. % thiol, based on the weight of the polyol premix composition.

The thiol is used in conjunction with the bismuth and/or zinc catalyst. It is not precisely known what dynamics occur to make the catalyst/thiol mixture produce a hydrolytically stable catalyst for storage in a polyol premix composition. Without desiring to be bound by any particular theory at this time, it nonetheless is thought that the thiol compound stabilizes some or all of the ligands on the bismuth/zinc catalyst, preventing access to the catalyst by water molecules, thereby inhibiting hydrolysis of the metallic catalyst.

In one embodiment, the thiol is a liquid, or a solid dispersed in a liquid diluent, at ambient temperature and pressure. The thiol can either be a monofunctional species with a single thiol moiety present, or polyfunctional with multiple thiol moieties and/or with other isocyanate-reactive moieties present. Examples of suitable thiols include, but are not limited to, saturated or unsaturated alkyl thiols, including those with aromatic substitutions (e.g. benzyl thiol), mercaptoacetates, mercaptopropionates, poly(ethylene glycol) methyl ether thiols, dithiols, bis-PEG-thiols, trithiols, thioglycerol, HSCH₂CH(OH)CH₂OH, thiol-PEG-alcohols, cysteine and derivatives and mixtures thereof.

The polyurethane catalyst of this disclosure advantageously is mixed with at least an equimolar amount of the thiol in a suitable diluent, and preferably is mixed with a stoichiometric excess of the thiol. As long as this proportional requirement is met, the thiol/catalyst ratio may otherwise vary widely. It is preferred, however, that the molar ratio of thiol moieties to active metal species of the metallic catalyst ranges from 1:1 to 1000:1, preferably from 1.1:1 to 10:1, preferably from 2:1 to 6:1, and especially from 2:1 to 4:1. The diluent may make up anywhere from 0 to 99 wt. %, preferably 40 to 80 wt. % of the catalyst/thiol/diluent mixture, based on the weight of this mixture. Examples of the diluent include polyols, alcohols, ketones, ethers, esters, cyclic and acyclic alkanes, alkenes, alkynes, hydrocarbons, other polar and non-polar solvents, etc., and combinations of these.

The blowing agent may be selected from a wide variety of blowing agents. The water employed in the polyol premix serves as a part of the blowing agent; thus, a mixture of blowing agents can be employed. In certain embodiments the blowing agent comprises one or more hydrohaloolefins, and optionally a hydrocarbon, fluorocarbon, chlorocarbon, hydrochlorofluorocarbon, hydrofluorocarbon, halogenated hydrocarbon, ether, ester, alcohol, aldehyde, ketone, organic acid, water, other gas generating material, or combinations thereof. Examples of blowing agents include: halogenated olefins, e.g. 1233zd, 1234ze, 1,1,1,4,4,4-hexafluoro-2-butene (1334mzz, and 1,2-dichloroethylene); hydrocarbons, e.g. cyclopentane, n-pentane, isopentane, and isobutane); hydrofluorocarbons, e.g. HFC-134a, HFC-245fa, HFC-365mfc; hydrochlorofluorocarbons, e.g. HCFC-141b; fluorocarbons; chlorocarbons; chlorofluorocarbons, e.g. CFC-11); halogenated ethers; ethers; esters, e.g. methyl formate); aldehydes; ketones, e.g. acetone); CO₂-generating materials, e.g. water and formic acid); and combinations of these.

In one embodiment, the blowing agent comprises a hydrohaloolefin, preferably comprising at least one or a combination of 1234ze(E), 1233zd(E), and isomer blends thereof, and/or 1336mzzm(Z), and optionally a hydrocarbon, fluorocarbon, chlorocarbon, fluorochlorocarbon, halogenated hydrocarbon, ether, fluorinated ether, ester, alcohol, aldehyde, ketone, organic acid, gas generating material, water or combinations thereof.

The hydrohaloolefin preferably comprises at least one halooalkene such as a fluoroalkene or chlorofluoroalkene containing from 3 to 4 carbon atoms and at least one carbon-carbon double bond. Preferred hydrohaloolefins non-exclusively include trifluoropropenes, tetrafluoropropenes such as (1234), pentafluoropropenes such as (1225), chlorotrifloropropenes such as (1233), chlorodifluoropropenes, chlorotrifluoropropenes, chlorotetrafluoropropenes, hexafluorobutenes (1336) and combinations of these. More preferred for the compounds are the tetrafluoropropene, pentafluoropropene, and chlorotrifluoropropene compounds in which the unsaturated terminal carbon has not more than one F or Cl substituent. Included are 1,3,3,3-tetrafluoropropene (1234ze); 1,1,3,3-tetrafluoropropene; 1,2,3,3,3-pentafluoropropene (1225ye), 1,1,1-trifluoropropene; 1,2,3,3,3-pentafluoropropene, 1,1,1,3,3-pentafluoropropene (1225zc) and 1,1,2,3,3-pentafluoropropene (1225yc); (Z)-1,1,1,2,3-pentafluoropropene (1225yez); 1-chloro-3,3,3-trifluoropropene (1233zd), 1,1,1,4,4,4-hexafluorobut-2-ene (1336mzzm) or combinations thereof, and any and all stereoisomers of each of these.

Preferred hydrohaloolefins have a Global Warming Potential (GWP) of not greater than 150, more preferably not greater than 100 and even more preferably not greater than 75. As used herein, “GWP” is measured relative to that of carbon dioxide and over a 100-year time horizon, as defined in “The Scientific Assessment of Ozone Depletion, 2002, a report of the World Meteorological Association's Global Ozone Research and Monitoring Project,” which is incorporated herein by reference. Preferred hydrohaloolefins also preferably have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

Further examples of the blowing agent non-exclusively include organic acids that produce CO₂ and/or CO, hydrocarbons; ethers, halogenated ethers; esters, alcohols, aldehydes, ketones, pentafluorobutane; pentafluoropropane; hexafluoropropane; heptafluoropropane; trans-1,2 dichloroethylene; methylal, methyl formate; 1-chloro-1,2,2,2-tetrafluoroethane (124); 1,1-dichloro-1-fluoroethane (141b); 1,1,1,2-tetrafluoroethane (134a); 1,1,2,2-tetrafluoroethane (134); 1-chloro 1,1-difluoroethane (142b); 1,1,1,3,3-pentafluorobutane (365mfc); 1,1,1,2,3,3,3-heptafluoropropane (227ea); trichlorofluoromethane (11); dichlorodifluoromethane (12); dichlorofluoromethane (22); 1,1,1,3,3,3-hexafluoropropane (236fa); 1,1,1,2,3,3-hexafluoropropane (236ea); 1,1,1,2,3,3,3-heptafluoropropane (227ea), difluoromethane (32); 1,1-difluoroethane (152a); 1,1,1,3,3-pentafluoropropane (245fa); butane; isobutane; normal pentane; isopentane; cyclopentane, or combinations thereof. In certain embodiments the blowing agent includes a combination of water and/or normal pentane, isopentane or cyclopentane, which may be provided with one or a combination of the hydrohaloolefin blowing agents discussed herein. The blowing agent is preferably present in the polyol premix composition in an amount of from 1 wt. % to 30 wt. %, preferably from 3 wt. % to 25 wt. %, and more preferably from 5 wt. % to 25 wt. %, by weight of the polyol premix composition. These amounts do not count the water present in the premix composition. For example, the polyol premix composition may include from 1 wt. % to 30 wt. %, of (nonaqueous) blowing agent and from 1 to 10 wt. % water.

The polyol, which includes mixtures of polyols, can be any polyol or polyol mixture that reacts in a known fashion with an isocyanate in preparing a polyurethane or polyisocyanurate foam. Useful polyols comprise one or more of a sucrose containing polyol; phenol, a phenol formaldehyde containing polyol; a glucose containing polyol; a sorbitol containing polyol; a methylglucoside containing polyol; an aromatic polyester polyol; glycerol; ethylene glycol; diethylene glycol; propylene glycol; graft copolymers of polyether polyols with a vinyl polymer; a copolymer of a polyether polyol with a polyurea; one or more of (a) condensed with one or more of (b), wherein (a) is selected from glycerine, ethylene glycol, diethylene glycol, trimethylolpropane, ethylene diamine, pentaerythritol, soy oil, lecithin, tall oil, palm oil, and castor oil; and (b) is selected from ethylene oxide, propylene oxide, a mixture of ethylene oxide and propylene oxide; and combinations thereof. The polyol component is usually present in the polyol premix composition in an amount of from 60 wt. % to 95 wt. %, preferably from 65 wt. % to 95 wt. %, and more preferably from 70 wt. % to 90 wt. %, by weight of the polyol premix composition.

The polyol premix composition also contains a surfactant. The surfactant is preferably used to form a foam from the mixture, as well as to control the size of the bubbles of the foam so that a foam of a desired cell structure is obtained. Preferably, a foam with small bubbles or cells therein of uniform size is desired since it has the most desirable physical properties such as compressive strength and thermal conductivity. Also, it is advantageous to have a foam with stable cells that do not collapse prior to forming or during foam rise.

Surfactants for use in the preparation of polyurethane or polyisocyanurate foams are well-known to those skilled in the art, and many are commercially available. Such materials have been found to be applicable over a wide range of formulations allowing uniform cell formation and maximum gas entrapment to achieve very low density foam structures. The surfactant can comprise a silicone surfactant or a non-silicone surfactant or a combination thereof. The preferred silicone surfactant comprises a polysiloxane polyoxyalkylene block co-polymer. Some representative silicone surfactants useful for this disclosure are Momentive's L-5130, L-5180, L-5340, L-5440, L-6100, L-6900, L-6980 and L-6988; Dow Corning's DC-193, DC-197, DC-5582, and DC-5598; and B-8404, B-8407, B-8409 and B-8462 from Evonik Industries AG of Essen, Germany. Others are disclosed in U.S. Pat. Nos. 2,834,748; 2,917,480; 2,846,458 and 4,147,847. The surfactant is present in the polyol premix composition in an amount of from 0.5 wt. % to 6.0 wt. %, preferably from 1.0 wt. % to 4.0 wt. %, and more preferably from 1.5 wt. % to 3.0 wt. %, by weight of the polyol premix composition.

Examples of non-silicone surfactants include oxyethylated alkylphenols, oxyethylated fatty alcohols, paraffin oils, castor oil esters, ricinoleic acid esters, turkey red oil, groundnut oil, paraffins, silicone surfactants and fatty alcohols. A preferred non-silicone surfactant is Vorasurf 504, which is commercially available from The Dow Chemical Company.

The catalyst comprises a metal-containing catalyst, referred to herein as a “metallic catalyst” and preferably is an organometallic or metal salt catalyst. In one embodiment of the disclosure, the catalyst is preferably a zinc-based catalyst, or a bismuth-based catalyst, or a combination of a zinc-based catalyst and a bismuth-based catalyst. In one embodiment of the disclosure, the catalyst is a metal-containing non-amine catalyst, such as an organometallic compound or a metal salt. In one embodiment of the disclosure, the B-side composition is free of added amine catalyst. In one embodiment of the disclosure, the metallic catalyst may be combined with an optional potassium-based cocatalyst such as potassium acetate or potassium octoate. In one embodiment of the disclosure, the catalyst may include an optional amine cocatalyst. Examples of suitable amine cocatalysts include aliphatic or aromatic, cyclic or acyclic tertiary amines. Preferred optional amine cocatalysts include Polycat 8 (Air Products), Polycat 12 (Air Products), Polycat 203 (Air Products), Polycat 204 (Air Products), Polycat 210 (Air Products), Polycat 211 (Air Products), Polycat 218 (Air Products), Dabco 2040 (Air Products), Dabco T (Air Products), RC-102 (Rhein Chemie), Jeffcat DMDEE (Huntsman), Jeffcat DM-70 (Huntsman), Jeffcat ZR-70 (Huntsman), Jeffcat DMP (Huntsman), N.N-dimethyl-p-toluene, N,N-dimethylbenzylamine, N-ethylmorpholine, N-methylmorpholine, dimorpholinodimethylether, and triethanolamine.

Examples of metal salt or organometallic catalytic compounds include, but are not limited to, organic salts, Lewis acid halides, and the like, of bismuth and/or zinc. Nonexclusive examples of such metal salt or organometallic catalysts include, but are not limited to, zinc oxide, zinc nitrate, zinc acetate, zinc neodecanoate, zinc octoate, zinc hexanoate, zinc acetylacetonate, zinc ethoxide, zinc propoxide, zinc butoxide, zinc isopropoxide, zinc 2-ethylhexanoate, zinc salts of carboxylic acids, bismuth nitrate, bismuth neodecanoate, bismuth octoate, bismuth 2-ethylhexanoate, bismuth salts of carboxylic acids, BiCAT Z, BiCAT 8, BiCAT 8106, BiCAT 8108, BiCAT 8118, BiCAT 8210, BiCAT 8840, BiCAT 8842, K-Kat XK-651, K-Kat XK-661, K-Kat XK-635, K-Kat XK-604, K-Kat XK-614, K-Kat XK-617, K-Kat XK-618, K-Kat XC-B221, Reaxis C739W50, Reaxis C739E50, Reaxis C716, Reaxis C717, Reaxis C726, Reaxis C708, Reaxis C616, Reaxis C620, Troychem Zinc 8, TROYMAX Zinc 8, TROYMAX Zinc 10, TROYMAX Zinc 12, TROYMAX Zinc 16, TROYMAX Bismuth 24 and combinations thereof. In certain preferred embodiments the catalyst is present in the polyol premix composition in an amount of from 0.001 wt. % to 5.0 wt. %, 0.01 wt. % to 3.0 wt. %, preferably from 0.3 wt. % to 2.5 wt. %, and more preferably from 0.35 wt. % to 2.0 wt. %, by weight of the polyol premix composition. While these are usual amounts, the quantity amount of the foregoing catalyst can vary widely, and the appropriate amount can be easily be determined by those skilled in the art.

The preparation of polyurethane or polyisocyanurate foams using the compositions described herein may follow any of the methods well known in the art can be employed. In general, polyurethane or polyisocyanurate foams are prepared by combining an isocyanate, the polyol premix composition, and other materials such as optional flame retardants, colorants, or other additives. These foams can be rigid, or semi-rigid, and can have a closed cell structure, an open cell structure or a mixture of open and closed cells.

It is convenient in many applications to provide the components for polyurethane or polyisocyanurate foams in pre-blended formulations. Most typically, the foam formulation is pre-blended into two components. The isocyanate and optionally other isocyanate compatible raw materials, including but not limited to blowing agents and certain silicone surfactants, comprise the first component, commonly referred to as the “A” component, or A side composition. The polyol mixture composition, including surfactant, catalysts, blowing agents, and optional other ingredients comprise the second component, commonly referred to as the “B” component or B-side composition. In any given application, the “B” component may not contain all the above listed components, for example some formulations omit the flame retardant if flame retardancy is not a required foam property. Accordingly, polyurethane or polyisocyanurate foams are readily prepared by bringing together the A and B-side components either by hand mix for small preparations and, preferably, machine mix techniques to form blocks, slabs, laminates, pour-in-place panels and other items, spray applied foams, froths, and the like. Optionally, other ingredients such as flame retardants, colorants, auxiliary blowing agents, water, and even other polyols can be added as a stream to the mix head or reaction site. Most conveniently, however, they are all incorporated into one B component as described above.

A foamable composition suitable for forming a polyurethane or polyisocyanurate foam may be formed by reacting an organic polyisocyanate and the polyol premix composition described above. Any organic polyisocyanate can be employed in polyurethane or polyisocyanurate foam synthesis inclusive of aliphatic and aromatic polyisocyanates. Suitable organic polyisocyanates include aliphatic, cycloaliphatic, araliphatic, aromatic, and heterocyclic isocyanates that are well known in the field of polyurethane chemistry. Preferred as a class are the aromatic polyisocyanates.

Representative organic polyisocyanates correspond to the formula: R(NCO)_{z} wherein R is a polyvalent organic radical that is either aliphatic, aralkyl, aromatic or mixtures thereof, and z is an integer that corresponds to the valence of R and is at least two. Representative of the organic polyisocyanates contemplated herein includes, for example, the aromatic diisocyanates such as 2,4-toluene diisocyanate, 2,6-toluene diisocyanate, mixtures of 2,4- and 2,6-toluene diisocyanate, crude toluene diisocyanate, methylene diphenyl diisocyanate, crude methylene diphenyl diisocyanate and the like; the aromatic triisocyanates such as 4,4′,4″-triphenylmethane triisocyanate, 2,4,6-toluene triisocyanates; the aromatic tetraisocyanates such as 4,4′-dimethyldiphenylmethane-2,2′5,5-′tetraisocyanate, and the like; arylalkyl polyisocyanates such as xylylene diisocyanate; aliphatic polyisocyanate such as hexamethylene-1,6-diisocyanate, lysine diisocyanate methylester and the like; and mixtures thereof. Other organic polyisocyanates include polymethylene polyphenylisocyanate, hydrogenated methylene diphenylisocyanate, m-phenylene diisocyanate, naphthylene-1,5-diisocyanate, 1-methoxyphenylene-2,4-diisocyanate, 4,4′-biphenylene diisocyanate, 3,3′-dimethoxy-4,4′-biphenyl diisocyanate, 3,3′-dimethyl-4,4′-biphenyl diisocyanate, and 3,3′-dimethyldiphenylmethane-4,4′-diisocyanate; Typical aliphatic polyisocyanates are alkylene diisocyanates such as trimethylene diisocyanate, tetramethylene diisocyanate, and hexamethylene diisocyanate, isophorene diisocyanate, 4,4′-methylenebis(cyclohexyl isocyanate), and the like; typical aromatic polyisocyanates include m-, and p-phenylene disocyanate, polymethylene polyphenyl isocyanate, 2,4- and 2,6-toluenediisocyanate, dianisidine diisocyanate, bitoylene isocyanate, naphthylene 1,4-diisocyanate, bis(4-isocyanatophenyl)methene, bis(2-methyl-4-isocyanatophenyl)methane, and the like. Preferred polyisocyanates are the polymethylene polyphenyl isocyanates, particularly the mixtures containing from 30 to 85 percent by weight of methylenebis(phenyl isocyanate) with the remainder of the mixture comprising the polymethylene polyphenyl polyisocyanates of functionality higher than 2. These polyisocyanates are prepared by conventional methods known in the art. In one embodiment of the disclosure, the polyisocyanate and the polyol are employed in amounts that will yield an NCO/OH stoichiometric ratio in a range of from 0.9 to 7.0. In one embodiment of the disclosure, the NCO/OH equivalent ratio is, preferably, 1.0 or more and 3.0 or less, with the ideal range being from 1.1 to 2.5. Especially suitable organic polyisocyanates include polymethylene polyphenyl isocyanate, methylenebis(phenyl isocyanate), toluene diisocyanates, and combinations thereof.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art, including, but not limited to, glycine salts, tertiary amine trimerization catalysts, quaternary ammonium carboxylates, and alkali metal carboxylic acid salts and mixtures of the various types of catalysts. Preferred species within the classes are potassium acetate, potassium octoate, and sodium N-(2-hydroxy-5-nonylphenol)methyl-N-methylglycinate.

A conventional flame retardant can also be incorporated, preferably in amount of not more than 30 percent by weight of the combined A and B-sides. Examples of the optional flame retardant include tris(2-chloroethyl)phosphate, tris(2-chloropropyl)phosphate, tris(2,3-dibromopropyl)phosphate, tris(1,3-dichloropropyl)phosphate, tri(2-chloroi sopropyl)phosphate, tricresyl phosphate, tri(2,2-dichloroisopropyl)phosphate, diethyl N,N-bis(2-hydroxyethyl)aminomethylphosphonate, dimethyl methylphosphonate, tri(2,3-dibromopropyl)phosphate, tri(1,3-dichloropropyl)phosphate, and tetra-kis-(2-chloroethyl)ethylene diphosphate, triethylphosphate, diammonium phosphate, various halogenated aromatic compounds, antimony oxide, aluminum trihydrate, polyvinyl chloride, melamine, and the like.

In addition to the previously described ingredients, other ingredients such as, dyes, fillers, pigments and the like can be included in the preparation of the foams. Dispersing agents and cell stabilizers can be incorporated into the present blends. Conventional fillers for use herein include, for example, aluminum silicate, calcium silicate, magnesium silicate, calcium carbonate, barium sulfate, calcium sulfate, glass fibers, carbon black and silica. The filler, if used, is normally present in an amount by weight ranging from 5 parts to 100 parts per 100 parts of polyol. A pigment that can be used herein can be any conventional pigment such as titanium dioxide, iron oxide, antimony oxide, chrome green, chrome yellow, iron blue siennas, molybdate oranges and organic pigments such as para reds, benzidine yellow, toluidine red, toners and phthalocyanines.

The polyurethane or polyisocyanurate foams produced can vary in density (in-place density) from 0.5 pounds per cubic foot to 60 pounds per cubic foot, preferably from 1.0 to 20.0 pounds per cubic foot, and most preferably from 1.5 to 6.0 pounds per cubic foot. The density obtained is a function of how much of the blowing agent or blowing agent mixture plus the amount of auxiliary blowing agent, such as water or other co-blowing agents is present in the A and/or B components, or alternatively added at the time the foam is prepared. These foams can be rigid, or semi-rigid foams, and can have a closed cell structure, an open cell structure or a mixture of open and closed cells. These foams are used in a variety of well-known applications, including but not limited to thermal insulation, cushioning, flotation, packaging, adhesives, void filling, crafts and decorative, and shock absorption.

### Specific Embodiments

Accelerated Aging Study Procedure

Load sufficient amount of B-side formulation, including blowing agent (add 10% extra to account for losses when vessels are opened), into steel pressure vessel along with ball bearings.

Record weight of material in pressure vessel.

Place vessel on roller system to mix contents for 30-60 minutes.

Decant required amount of B-side formulation and make cup foams (45 g B-side and 50 g PAPI 27 for reactivity measurement, and 71 g B-side and 79 g PAPI 27 for FOAMAT analysis), noting cream time, gel time, tack-free time, foam height versus time, and free-rise densities. These data indicate the initial reactivity of these systems.

Place pressure vessel in secondary container and place in an oven at 50° C. (122° F.). Monitor pressure in vessel to ensure that system is not over-pressured and that blowing agent is not escaping.

Each week, remove pressure vessel from oven and cool down to room temperature, by mixing on roller system for about 4 hrs.

Once at room temperature, check initial weight of containers. Decant required amount of B-side formulation and make cup foams as described above, again noting cream time, gel time, tack-free time, foam height versus time, and free-rise densities. Purge vessels with nitrogen if flow of B-side is slow. Include analysis of a freshly made control to account for changes in ambient conditions.

Measure remaining amount of material in vessel.

Return vessels to oven and repeat process every week for 2 weeks.

This procedure is employed for the following Examples and Comparative Experiments using the materials described therein.

Materials List

Polyol 1 is a sucrose/glycerin-initiated polyether polyol with approximately a nominal hydroxyl functionality of 4 and OH #=360 mg KOH/g, available from The Dow Chemical Company, and Polyol 2 is a glycerin-initiated polyether polyol with a nominal hydroxyl functionality of approximately 3 and an OH #=235 mg KOH/g, also available from The Dow Chemical Company. PAPI™ 27 brand polymeric MDI is a polymethylene polyphenylisocyanate that contains MDI, and is available from The Dow Chemical Company.

### Example 1

Rigid foam formulation with HCFO, organometallic or metal salt catalyst and thiol stabilizer. Note: catalyst loading is adjusted to match gel times for both formulations, and organometallic or metal salt catalyst, thiol and glycol are pre-blended before adding into formulation.

| | | Weight |
|---|---|---|
| | Amount | percent |
| Ingredients | (grams) | (%) |
| Polyol 1 | 394.64 | 57.95% |
| Polyol 2 | 54.20 | 7.96% |
| Tris (1-chloro-2-propyl) phosphate (TCPP) | 107.02 | 15.72% |
| Water | 20.04 | 2.94% |
| Zinc catalyst available as K-Kat XK-664 (King | 9.00 | 1.32% |
| Industries Inc.) | | |
| Trimethylolpropane tris(2-mercaptoacetate) | 2.02 | 0.30% |
| (Sigma Aldrich) | | |
| Diethylene glycol | 11.48 | 1.69% |
| DABCO K-15 (Air Products) | 1.50 | 0.22% |
| TEGOSTAB B-8462 (Evonik) | 15.00 | 2.20% |
| 1-chloro-3,3,3-trifluoropropene (Honeywell) | 66.00 | 9.69% |
| Total | 681.00 | 100.00% |

### Results:

| | Day | Day | | Day | Day | | Day | Day | Overall |
|---|---|---|---|---|---|---|---|---|---|
| Formulation 1 | 0-1 | 0-2 | Control | 7-1 | 7-2 | Control | 14-1 | 14-2 | %Δ |
| Cream (s) | 25 | 25 | 23 | 25 | 28 | 25 | 30 | 27 | 16.3% |
| Gel (s) | <123 | 119 | 119 | 123 | 122 | 117 | 122 | 117 | 0.2% |
| Tack free (s) | 320 | 295 | 310 | 325 | 308 | 285 | 290 | 291 | −4.0% |

| | | | | |
|---|---|---|---|---|
| FRD* (pcf) | 1.766 | 1.900 | 1.944 | 10.1% |

*Free Rise Density

### Example 2

Rigid foam formulation with HCFO, organometallic or metal salt catalyst and thiol stabilizer, with same metal content as in Comparative Experiment 4. The organometallic or metal salt catalyst, thiol and glycol are pre-blended before adding into formulation.

| | Amount | Weight percent |
|---|---|---|
| Ingredients | (grams) | (%) |
| Polyol 1 | 403.65 | 59.27% |
| Polyol 2 | 55.43 | 8.14% |
| TCPP (ICL-IP) | 109.45 | 16.07% |
| Water | 20.50 | 3.01% |
| Zinc catalyst available as K-KAT XK-664 | 3.75 | 0.55% |
| (King Industries Inc.) | | |
| Trimethylolpropane tris(2-mercaptoacetate) | 0.84 | 0.12% |
| (Sigma Aldrich) | | |
| Diethylene glycol | 4.78 | 0.70% |
| DABCO K-15 (Air Products) | 1.50 | 0.22% |
| TEGOSTAB B-8462 (Evonik) | 15.00 | 2.20% |
| 1-chloro-3,3,3-trifluoropropene (Honeywell) | 66.00 | 9.69% |
| Total | 681.00 | 100.00% |

### Results:

| | Day | Day | | Day | Day | | Day | Day | Overall |
|---|---|---|---|---|---|---|---|---|---|
| Formulation 2 | 0-1 | 0-2 | Control | 7-1 | 7-2 | Control | 14-1 | 14-2 | %Δ |
| Cream (s) | 24 | 25 | 32 | 26 | 30 | 28 | 30 | 27 | 4.6% |
| Gel (s) | 160 | 157 | 160 | 135 | 134 | 150 | 133 | 137 | −13.9% |
| Tack free (s) | 410 | 418 | 415 | 328 | 315 | 360 | 325 | 310 | −20.8% |

| | | | | |
|---|---|---|---|---|
| FRD (pcf) | 1.940 | 1.889 | 1.949 | 10.1% |

### Example 3

Rigid foam formulation with HCFO, organometallic or metal salt catalyst and a different thiol stabilizer (cetyl thiol), with same metal content as in Comparative Experiment 4. Note: catalyst loading and formulation is adjusted to match gel time of ca. 120 s, and organometallic or metal salt catalyst, thiol and a portion of Polyol 2 are pre-blended before adding into formulation.

| | Amount | Weight percent |
|---|---|---|
| Ingredients | (grams) | (%) |
| Polyol 1 | 346.88 | 50.94% |
| Polyol 2 | 76.53 | 11.24% |
| TCPP (ICL-IP) | 94.06 | 13.82% |
| Water | 17.62 | 2.59% |
| Zinc catalyst available as K-KAT XK-664 | 9.00 | 1.32% |
| (King Industries Inc.) | | |
| Cetyl Thiol (TCI Chemicals) | 7.11 | 1.04% |
| Diethylene glycol | 37.50 | 5.51% |
| DABCO K-15 (Air Products) | 11.25 | 1.65% |
| TEGOSTAB B-8462 (Evonik) | 15.00 | 2.20% |
| 1-chloro-3,3,3-trifluoropropene (Honeywell) | 66.00 | 9.69% |
| Total | 681.00 | 100.00% |

### Results:

| | Day | Day | | Day | Day | | Day | Day | Overall |
|---|---|---|---|---|---|---|---|---|---|
| Formulation 3 | 0-1 | 0-2 | Control | 7-1 | 7-2 | Control | 14-1 | 14-2 | %Δ |
| Cream (s) | 30 | 28 | 31 | 26 | 26 | 32 | 24 | 28 | −11.0% |
| Gel (s) | 118 | 118 | 122 | 105 | 107 | 132 | 102 | 108 | −16.0% |
| Tack free (s) | 263 | 287 | 286 | 230 | 240 | 330 | 228 | 225 | −22.3% |

| | | | | |
|---|---|---|---|---|
| FRD (pcf) | 1.800 | 1.789 | 1.757 | −2.4% |

### Comparative Experiment 4 (not an Embodiment of the Disclosure)

Rigid foam formulation with HCFO and just organometallic or metal salt catalyst.

| | Amount | Weight percent |
|---|---|---|
| Ingredients | (grams) | (%) |
| Polyol 1 | 543.36 | 59.72% |
| Polyol 2 | 74.62 | 8.20% |
| TCPP (ICL-IP) | 147.34 | 16.19% |
| Water | 27.60 | 3.03% |
| Zinc catalyst available as K-KAT XK-664 | 5.00 | 0.55% |
| (King Industries Inc.) | | |
| DABCO K-15 (Air Products) | 2.00 | 0.22% |
| TEGOSTAB B-8462 (Evonik) | 20.00 | 2.20% |
| 1-chloro-3,3,3-trifluoropropene (Honeywell) | 90.00 | 9.89% |
| Total | 910.00 | 100.00% |

### Results:

| | Day | Day | | Day | Day | | Day | Day | Overall |
|---|---|---|---|---|---|---|---|---|---|
| Formulation 4 | 0-1 | 0-2 | Control | 7-1 | 7-2 | Control | 14-1 | 14-2 | %Δ |
| Cream (s) | 28 | 25 | 25 | 27 | 30 | 27 | 31 | 29 | 14.3% |
| Gel (s) | 121 | 126 | 115 | 170 | 165 | 123 | 214 | 208 | 74.0% |
| Tack free (s) | 288 | 262 | 265 | 400 | 395 | 240 | | 462 | 75.2% |

| | | | | |
|---|---|---|---|---|
| FRD (pcf) | 1.731 | 1.832 | 1.857 | 7.3% |

It can be seen by comparing the results of Ex.s 1-3 to the results of Comparative Experiment 4, that exclusion of the thiol results in a significant change (>25%) in the gel time and tack-free times for the system, suggesting that catalytic activity in the formulation has diminished over time.

### Example 5

Rigid foam formulation with HCFO, bismuth-based organometallic or metal salt catalyst and thiol stabilizer. The catalyst is a bismuth catalyst available as BiCAT 8842 (Shepherd Chemical Company). Note: the catalyst and thiol are pre-blended in a fraction of the polyol mixture before being added into formulation.

| | Amount | Weight percent |
|---|---|---|
| Ingredients | (grams) | (%) |
| Polyol 1 | 397.60 | 58.38% |
| Polyol 2 | 54.60 | 8.02% |
| Tris (1-chloro-2-propyl) phosphate (TCPP) | 107.80 | 15.83% |
| Water | 18.58 | 2.73% |
| Bismuth catalyst available as BiCAT 8842 | 12.00 | 1.76% |
| (Shepherd Chemical Company) | | |
| Trimethylolpropane tris(2-mercaptoacetate) | 3.42 | 0.50% |
| (TCI Chemicals) | | |
| DABCO K-15 (Air Products) | 6.00 | 0.88% |
| TEGOSTAB B-8462 (Evonik) | 15.00 | 2.20% |
| 1-chloro-3,3,3-trifluoropropene (Honeywell) | 66.00 | 9.69% |
| Total | 681.00 | 100.00% |

### Results:

| | Day | Day | | Day | Day | | Day | Day | Overall |
|---|---|---|---|---|---|---|---|---|---|
| Formulation 5 | 0-1 | 0-2 | Control | 7-1 | 7-2 | Control | 14-1 | 14-2 | %Δ |
| Cream (s) | 29 | 26 | 24 | 18 | 24 | 23 | 25 | 24 | −3.9% |
| Gel (s) | 121 | 127 | 144 | 122 | 122 | 144 | 141 | 143 | 6.0% |
| Tack free (s) | 245 | 248 | 322 | 230 | 243 | 285 | 290 | 295 | 6.4% |

| | | | | |
|---|---|---|---|---|
| FRD* (pcf) | 2.003 | 2.172 | 2.125 | 6.1% |

### Comparative Experiment 6 (not an Embodiment of the Invention)

Rigid foam formulation with HCFO and just bismuth-based organometallic or metal salt catalyst.

| | Amount | Weight percent |
|---|---|---|
| Ingredients | (grams) | (%) |
| Polyol 1 | 404.95 | 59.47% |
| Polyol 2 | 55.61 | 8.17% |
| Tris (1-chloro-2-propyl) phosphate (TCPP) | 109.81 | 16.13% |
| Water | 20.57 | 3.02% |
| Bismuth catalyst available as BiCAT 8842 | 7.50 | 1.10% |
| (Shepherd Chemical Company) | | |
| DABCO K-15 (Air Products) | 1.50 | 0.22% |
| TEGOSTAB B-8462 (Evonik) | 15.00 | 2.20% |
| 1-chloro-3,3,3-trifluoropropene (Honeywell) | 66.00 | 9.69% |
| Total | 681.00 | 100.00% |

### Results:

| | Day | Day | | Day | Day | | Day | Day | Overall |
|---|---|---|---|---|---|---|---|---|---|
| Formulation 6 | 0-1 | 0-2 | Control | 7-1 | 7-2 | Control | 14-1 | 14-2 | %Δ |
| Cream (s) | 18 | 18 | 15 | 23 | 23 | 16 | 21 | 24 | 34.3% |
| Gel (s) | 106 | 105 | 110 | 195 | 193 | 105 | 211 | 215 | 100.0% |
| Tack free (s) | 215 | 210 | 215 | 480 | 464 | 198 | 530 | 532 | 153.5% |

| | | | | |
|---|---|---|---|---|
| FRD* (pcf) | 1.906 | 2.019 | 1.981 | 3.9% |

It can be seen by comparing the results of Ex. 5 to the results of Comparative Experiment 6, that exclusion of the thiol results in a significant change in the gel time and tack-free times for the system, suggesting that catalytic activity in the formulation has diminished over time.

Thus, the B-side composition of the disclosure provides unexpectedly improved shelf life, per the definition of shelf-life as provided herein. More specifically, the overall changes in physical properties are much smaller for the Examples than for the Comparative Experiments, meaning that those systems are more stable and have a longer shelf life, such as a shelf life of at least 4 months.

1. A B-side composition useful for preparing a rigid foam, the composition comprising a polyol, a surfactant, a blowing agent, a thiol compound, from 1 to 10 weight percent water, based on the weight of the composition, and an organometallic or metal salt catalyst wherein the metal of the catalyst comprises Zn or Bi.

2. The composition of claim 1 wherein the composition has a shelf life of at least 4 months.

3. The composition of claim 1 wherein the amount of water is from 2 to 5 wt. %.

4. The composition of claim 1 wherein the amount of water is from 3 to 5 wt. %.

5. The composition of claim 1 wherein the thiol is a saturated or unsaturated alkyl thiol, including alky thiols with aromatic substitutions (e.g. benzyl thiol), mercaptoacetates, mercaptopropionates, poly(ethylene glycol) methyl ether thiols, dithiols, bis-PEG-thiols, trithiols, thioglycerol, HSCH₂CH(OH)CH₂OH, thiol-PEG-alcohols, cysteine and derivatives and mixtures thereof.

6. The composition of claim 1 wherein the blowing agent comprises at least one of trans-1,3,3,3-tetrafluoropropene (1234ze) and 1-chloro-3,3,3-trifluoropropene (1233 zd).

7. The composition of claim 1 wherein a stoichiometric excess of the thiol is employed

8. The composition of claim 1 wherein the composition comprises from 60 to 95 wt. % polyol, from 0.5 to 6.0 wt. % surfactant, from 1 to 30 wt. % blowing agent, not counting water, from 0.0001 to 10 wt. % thiol compound, from 0.001 wt. % to 5.0 wt. % catalyst and from 1 to 10 wt. % water, based on 100 weight percent of the composition.

9. A rigid foam prepared from an admixture of: (a) an A-side composition comprising an isocyanate, and (b) the composition of claim 1.

10. A process comprising admixing a polyol, a surfactant, a blowing agent, a thiol compound, an organometallic or metal salt catalyst wherein the metal of the catalyst comprises Zn or Bi, and from 1 to 10 weight percent water, based on the weight of the composition, under conditions such that a B-side composition is prepared.
